(19) United States
(12) Patent Application Publication
(10) Pub. No.: US 2026/0052378 A1
(43) Pub. Date: Feb. 19, 2026

(54) USER EQUIPMENT TERMINAL AND METHOD FOR DYNAMIC CAPABILITY EXCHANGE CONFIGURATION

(71) Applicant: MEDIATEK INC., Hsinchu City (TW)

(72) Inventors: Keng-Ming Huang, Hsinchu City (TW); Hung-Lin Chang, Hsinchu City (TW); Te-Sheng Tsai, Hsinchu City (TW); Yu-Jia Liang, Hsinchu City (TW); Chi-Chen Lee, Hsinchu City (TW)

(73) Assignee: MEDIATEK INC., Hsinchu City (TW)

(21) Appl. No.: 19/273,114

(22) Filed: Jul. 17, 2025

Related U.S. Application Data
(60) Provisional application No. 63/683,747, filed on Aug. 16, 2024.

(51) Int. Cl. H04W 8/24; H04W 76/27

(52) U.S. Cl. CPC H04W 8/24; H04W 76/27

(57) ABSTRACT

A method for performing a capability exchange with a network device by a user equipment (UE) terminal includes receiving a message from the network device, wherein the message comprises network vendor information for identifying a manufacturer of the network device; updating a capability configuration of the UE terminal based on the message; transmitting an update notification message to the network device to trigger a capability exchange procedure; and during the capability exchange procedure, transmitting capability report information to the network device. The capability report information includes the updated capability configuration and at least a portion of UE terminal vendor information for identifying a chipset manufacturer of the UE terminal.

### CROSS REFERENCE TO RELATED APPLICATIONS

This application claims the benefit of U.S. Provisional Application No. 63/683,747, filed on Aug. 16, 2024. The content of the application is incorporated herein by reference.

### BACKGROUND

In modern cellular networks, such as those defined by the 3rd Generation Partnership Project (3GPP), a user equipment (UE) terminal and a network device perform a capability exchange procedure to inform each other of their supported features and functionalities. The capability exchange is initiated by the network device sending a capability enquiry message, to which the UE terminal responds with a capability information message detailing its supported functions.

As network functions become increasingly complex, a UE terminal often needs to dynamically update its reported capabilities based on its operational context. Conventionally, this dynamic update is triggered by factors such as a change in the inserted Subscriber Identity Module (SIM) card or the Public Land Mobile Network (PLMN) identifier of the camped network.

However, these conventional triggers lack sufficient granularity. For example, a single network operator, identified by one PLMN, may deploy equipment from different infrastructure vendors. A UE terminal relying solely on the PLMN identifier cannot distinguish between these different vendors, preventing the UE terminal from optimizing its capability configuration for the specific network environment being connected. As a result, conventional capability exchange methods may lead to sub-optimal performance or interoperability issues.

### SUMMARY

In one embodiment, a method for performing a capability exchange with a network device by a user equipment (UE) terminal is disclosed. The method comprises receiving a message from the network device, wherein the message comprises network vendor information for identifying a manufacturer of the network device; updating a capability configuration of the UE terminal based on the message; transmitting an update notification message to the network device to trigger a capability exchange procedure; and during the capability exchange procedure, transmitting capability report information to the network device, wherein the capability report information comprises the updated capability configuration and at least a portion of UE terminal vendor information for identifying a chipset manufacturer of the UE terminal.

In another embodiment, a method for performing a capability exchange with a UE terminal by a network device is disclosed. The method comprises transmitting a message to the UE terminal, wherein the message comprises network vendor information for identifying a manufacturer of the network device and requests the UE terminal to report its capability information; and receiving capability report information from the UE terminal in response to the message, wherein the capability report information comprises a capability configuration of the UE terminal and at least a portion of UE terminal vendor information for identifying a chipset manufacturer of the UE terminal.

In another embodiment, a UE terminal is disclosed. The UE terminal comprises a transceiver, a processor coupled to the transceiver, and a non-volatile memory coupled to the processor and configured to store data. The transceiver is configured to receive a message from a network device. The message comprises network vendor information for identifying a manufacturer of the network device. The processor updates a capability configuration of the UE terminal based on the message. The processor controls the transceiver to transmit an update notification message to the network device to trigger a capability exchange procedure. During the capability exchange procedure, the processor controls the transceiver to transmit capability report information to the network device. The capability report information comprises the updated capability configuration and at least a portion of UE terminal vendor information for identifying a chipset manufacturer of the UE terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram of architecture for capability exchange between a network device and a user equipment (UE) terminal according to an embodiment of the present invention.

FIG. 2 is a sequence diagram illustrating a first option of the dynamic capability exchange method of the UE terminal in FIG. 1.

FIG. 3 is a sequence diagram illustrating a second option of the dynamic capability exchange method of the UE terminal in FIG. 1.

FIG. 4 is a sequence diagram illustrating a third option of the dynamic capability exchange method of the UE terminal in FIG. 1.

FIG. 5 is a sequence diagram illustrating a fourth option of the dynamic capability exchange method of the UE terminal in FIG. 1.

FIG. 6 is a functional block diagram illustrating the internal logic of the UE terminal for implementing the dynamic capability exchange method of the UE terminal in FIG. 1.

FIG. 7 is a flowchart of performing a method for performing the capability exchange with the network device by the UE terminal in FIG. 1.

### DETAILED DESCRIPTION

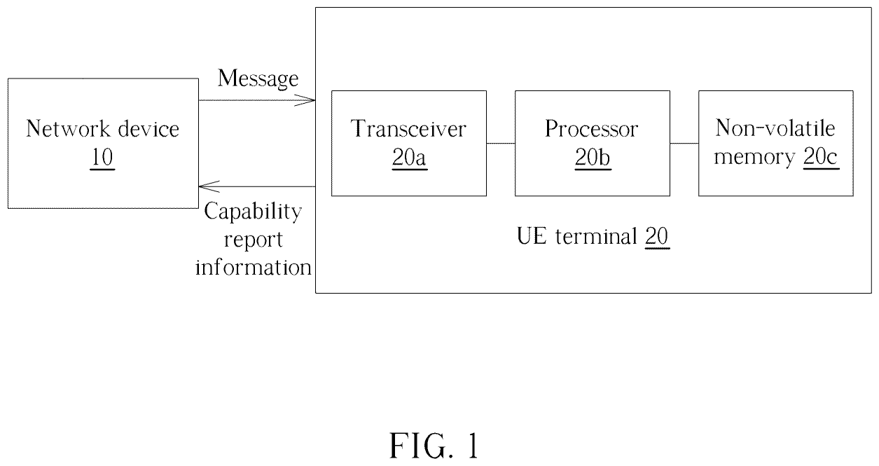

FIG. 1 is a schematic block diagram of architecture for capability exchange between a network device 10 and a user equipment (UE) terminal 20 according to an embodiment of the present invention. The architecture for capability exchange in FIG. 1 includes the network device 10 and the UE terminal 20. The network device 10, which may be a base station (gNB for 5G and eNB for 4G), is configured to communicate wirelessly with the UE terminal 20.

The communication in FIG. 1 enables a dynamic and adaptive capability exchange framework. The network device 10 transmits a message to the UE terminal 20. This message includes network vendor information that identifies a manufacturer of the network device 10. In response to a capability exchange procedure, the UE terminal 20 transmits capability report information to the network device 10. The capability report information includes an updated capability configuration of the UE terminal 20 and at least a portion of UE terminal vendor information identifying a chipset manufacturer of the UE terminal 20.

For efficiency, after the UE terminal 20 completes the capability reporting, the network device 10 may forward the capability report information to an Access and Mobility Management Function (AMF) in a Core Network. As such, when the UE terminal 20 subsequently performs a handover to a new network device under the jurisdiction of the same AMF, the AMF can directly provide the stored capability information to the new network device. This process avoids a repetitive capability enquiry procedure.

The UE terminal 20 includes a transceiver 20a, a processor 20b, and a non-volatile memory 20c. The transceiver 20a is configured to handle wireless communication, including receiving the message from the network device 10 and transmitting the capability report information and any update notification messages. The processor 20b is coupled to the transceiver 20a and the non-volatile memory 20c. The processor 20b is configured to execute instructions stored in the non-volatile memory 20c to perform the core logic. For instance, the processor 20b updates the capability configuration of the UE terminal 20 based on the received message. Updating capability configuration is performed in response to the processor 20b detecting at least one decision factor, such as a (Subscriber Identity Module) SIM card insertion, a camped network identifier, or a combination of the camped network identifier and the received network vendor information. Furthermore, the processor 20b is configured to selectively update the non-volatile memory 20c with the updated capability configuration to make the change persistent. The processor 20b performs the update by modifying specific capability categories stored in a database within the non-volatile memory 20c, such as radio frequency (RF) capabilities, Radio Resource Control (RRC) or Mobility Management (MM) capabilities, or an on/off state of a specific function. The non-volatile memory 20c is configured to store these instructions and the database of capability configurations.

In the UE terminal 20, the processor 20b is configured to update the capability configuration in response to detecting one or more defined decision factors. These decision factors and their corresponding modification targets are conceptually summarized in Table T1 below.

TABLE T1

| UE decision factor | Target UE configuration database for modification |
|---|---|
| 1. Inserted SIM (eSIM profile) | 1. 3GPP RRC and/or MM Capability Information |
| | 2. Specific function/operation ON/OFF switching |
| | 3. RF band and/or band combo supporting |
| 2. Camped/selected network | 1. 3GPP RRC and/or MM Capability Information |
| | 2. Specific function/operation ON/OFF switching |
| | 3. RF band and/or band combo supporting |
| 3. Camped/selected network + | 1. 3GPP RRC and/or MM Capability Information |
| Network vendor/version | 2. Specific function/operation ON/OFF switching |
| | 3. RF band and/or band combo supporting |
| | (the modification timing and procedure would be different) |

As shown in Table T1, a first decision factor is the insertion of a Subscriber Identity Module (SIM) card or the selection of an embedded SIM (eSIM) profile by the UE terminal 20. A second decision factor is an identifier of a network that the UE terminal 20 has camped on or selected, such as a Public Land Mobile Network (PLMN) identifier. Based on one or both of these decision factors, the processor 20b can modify various capability categories stored in the database of the non-volatile memory 20c. For example, these UE modification categories include 3rd Generation Partnership Project (3GPP) Radio Resource Control (RRC) and/or Mobility Management (MM) capability information, an ON/OFF switching state of a specific internal function or operation, and supported Radio Frequency (RF) bands or band combinations.

A third decision factor introduced by the embodiment is a combination of the camped network identifier and the network vendor information received from the network device 10. While the composite factor may target the same capability categories for modification, a main aspect of the embodiment is that the modification timing and procedure would be different. Specifically, based on the third decision factor, the processor 20b is configured to adaptively detect whether the intended capability update would affect an ongoing connection. Based on this detection, the processor 20b then decides on the appropriate procedure, such as performing the capability exchange immediately without interrupting the connection, or waiting to perform the exchange only after the connection is interrupted. Therefore, performing capability modification based on the third decision factor provides a more adaptive and robust update mechanism compared to conventional methods. Details of various options for performing the capability exchange are illustrated below.

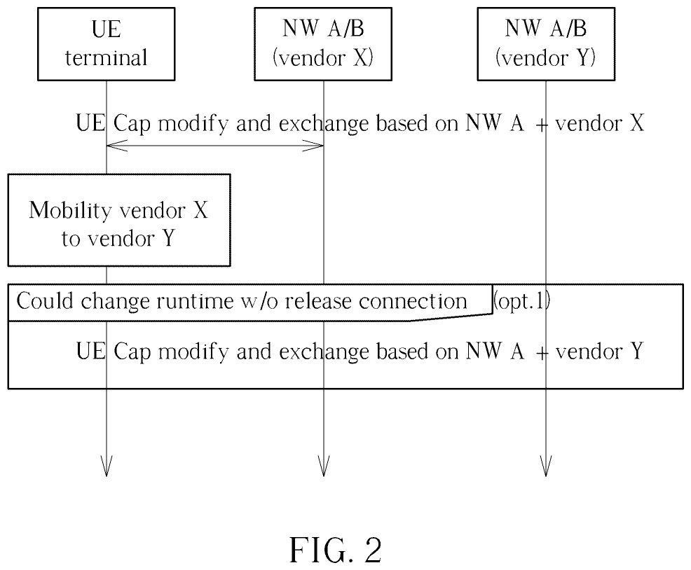

FIG. 2 is a sequence diagram illustrating a first option of the dynamic capability exchange method of the UE terminal 20. The procedure begins with the UE terminal 20 operating in a connected state within a network (NW A/B) provided by a network device associated with a first vendor, vendor X. In this initial state, the capability configuration of the UE terminal 20 is set or has been exchanged based on the environment of vendor X.

Subsequently, the UE terminal 20 performs a mobility procedure, such as a handover, moving from the network environment of vendor X to a new network environment still within NW A/B but now serviced by a network device associated with a second, different vendor, vendor Y. It is a main aspect of the first option that the UE terminal 20 maintains its ongoing connection throughout this mobility event.

After the mobility procedure, the processor 20b of the UE terminal 20 receives information identifying the new network vendor as vendor Y. The processor 20b detects this change and determines that a capability configuration update is required to optimize performance for vendor Y based on its internal logic. The processor 20b can further judge that performing this specific update will not affect the ongoing connection.

Based on the judgment, the UE terminal 20 can proceed with a runtime capability exchange without connection release. The processor 20b controls the transceiver 20a to transmit an update notification message (e.g., a Mobility Registration Update message) to the network to trigger the capability exchange procedure. The network then responds with a capability enquiry message. In response, the processor 20b controls the transceiver 20a to transmit capability report information containing the new, updated capability configuration optimized for vendor Y. Upon successful completion of the exchange, the UE terminal 20 continues its ongoing service under the new network environment of vendor Y with its capabilities appropriately reconfigured. The entire process demonstrates an adaptive and efficient update mechanism that enhances performance without disrupting the user experience.

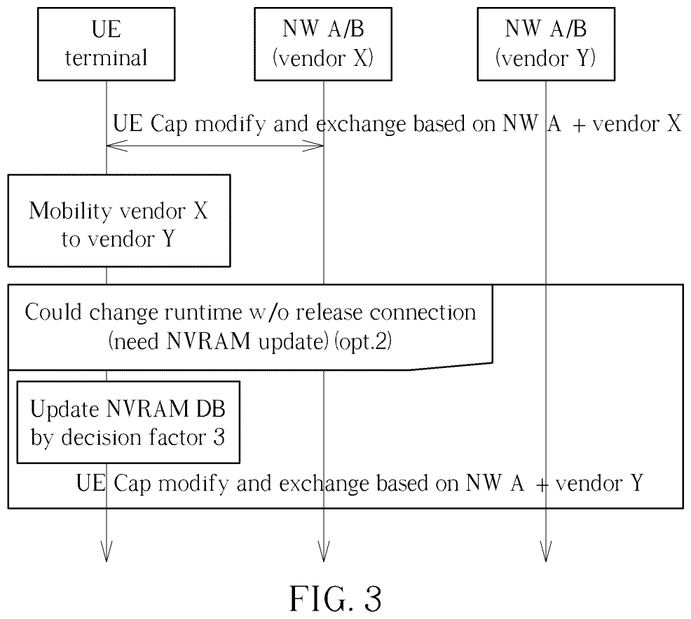

FIG. 3 is a sequence diagram illustrating a second option of the dynamic capability exchange method of the UE terminal 20. The second option is similar to the first option described in FIG. 2, with a key difference being that the new capability configuration is made persistent by updating a non-volatile memory 20c.

Similar to the first option, the procedure begins with the UE terminal 20 operating in a connected state within a network (NW A/B) provided by a network device associated with a first vendor, vendor X. Subsequently, the UE terminal 20 performs a mobility procedure, such as a handover, moving from the network environment of vendor X to a new network environment serviced by a network device associated with a second, different vendor, vendor Y, while maintaining its ongoing connection.

After the mobility procedure, the processor 20b of the UE terminal 20 detects the change to vendor Y and determines that a capability configuration update is required. The processor 20b judges that performing this update will not affect the ongoing connection. However, in the second option, the processor 20b also determines that the new configuration for vendor Y should be stored permanently for future use.

Based on this judgment, the UE terminal 20 can proceed with a runtime capability exchange that includes updating its non-volatile memory 20c. The processor 20b controls the transceiver 20a to transmit an update notification message to the network to trigger the capability exchange procedure. Concurrently or thereafter, the processor 20b also updates the capability configuration database within the non-volatile memory 20c based on the new decision factor (e.g., the combination of the network identifier and vendor Y's information).

Then, the network responds with a capability enquiry message, and the UE terminal 20 transmits its new capability report information. Upon successful completion, the UE terminal 20 continues its ongoing service without interruption. A key result of the second option is that the updated capability configuration is now persistently stored. Therefore, the UE terminal 20 can automatically apply this optimized configuration when it next encounters the network environment of vendor Y.

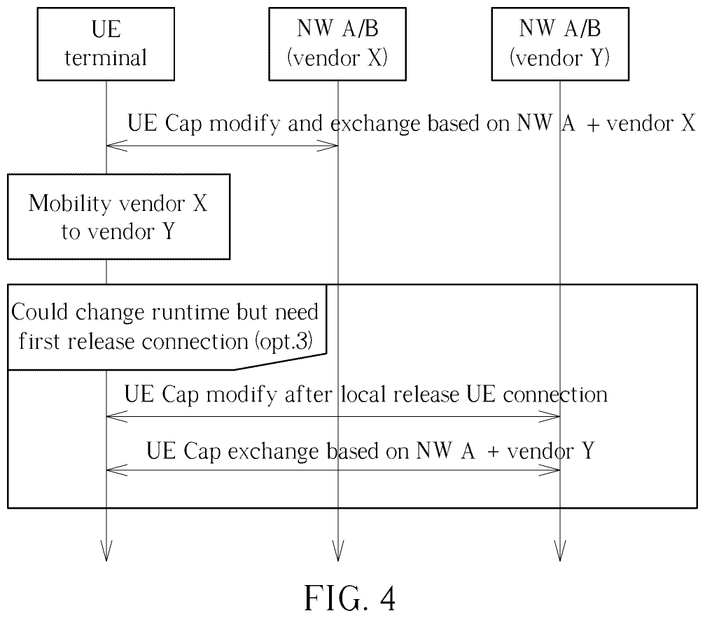

FIG. 4 is a sequence diagram illustrating a third option of the dynamic capability exchange method of the UE terminal 20. The third option prioritizes connection stability by postponing the capability update until after a connection is released. The procedure begins with the UE terminal 20 operating in a connected state within a network (NW A/B) provided by a network device associated with a first vendor, vendor X. Subsequently, the UE terminal 20 performs a mobility procedure, such as a handover, moving from the network environment of vendor X to a new network environment serviced by a network device associated with a second, different vendor, vendor Y.

After the mobility procedure, the processor 20b of the UE terminal 20 detects the change to vendor Y and determines that a capability configuration update is required. However, in the third option, the processor 20b judges that performing the required update would affect or disrupt the ongoing connection. It may be because the required change is fundamental to the current communication protocol or Radio Frequency (RF) configuration.

Based on the judgment, the processor 20b decides to postpone the capability exchange procedure. The UE terminal 20 continues its ongoing service, albeit with a sub-optimal capability configuration for vendor Y, until the current service is complete and the connection is released or interrupted.

Once the connection is released and the UE terminal 20 enters an idle state, the processor 20b proceeds with the postponed update. The processor 20b first modifies the capability configuration internally according to the requirements for vendor Y. After the internal modification, the processor 20b controls the transceiver 20a to transmit an update notification message (e.g., a Mobility Registration Update message) to the network to trigger the capability exchange procedure. The network then initiates the exchange. The UE terminal 20 responds by transmitting its capability report information containing the new, updated capability configuration. The third option ensures that capability updates are performed safely without risking the stability of an active connection.

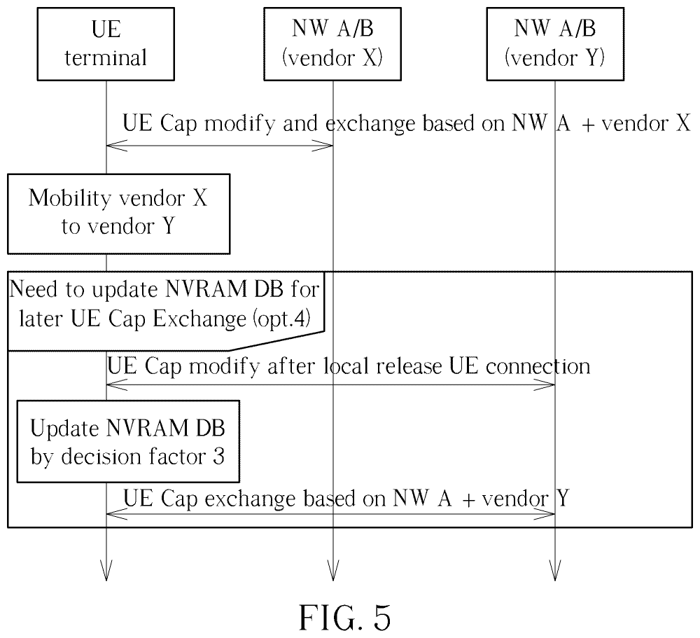

FIG. 5 is a sequence diagram illustrating a fourth option of the dynamic capability exchange method of the UE terminal 20. The fourth option is similar to the third option described in FIG. 4, with a key difference being that the new capability configuration is made persistent by updating a non-volatile memory 20c after the connection is released.

The procedure begins with the UE terminal 20 operating in a connected state within a network (NW A/B) provided by a network device associated with a first vendor, vendor X. Subsequently, the UE terminal 20 performs a mobility procedure, such as a handover, moving from the network environment of vendor X to a new network environment serviced by a network device associated with a second, different vendor, vendor Y.

After the mobility procedure, the processor 20b of the UE terminal 20 detects the change to vendor Y and determines that a capability configuration update is required. The processor 20b judges that performing the required update would affect or disrupt the ongoing connection. Furthermore, in the fourth option, the processor 20b also determines that the new configuration for vendor Y is an important setting that should be stored permanently.

Based on these judgments, the processor 20b decides to postpone the entire update procedure until after the connection is released. The UE terminal 20 continues its ongoing service until after a connection is released.

After the connection is released, the processor 20b can proceed with the postponed update. The processor 20b first modifies the capability configuration internally according to the requirements for vendor Y. The processor 20b then also updates the capability configuration database within the non-volatile memory 20c to make the change persistent. After these internal updates are complete, the processor 20b controls the transceiver 20a to transmit an update notification message to the network to trigger the capability exchange procedure. The network then initiates the exchange. The UE terminal 20 responds by transmitting its capability report information containing the new, updated capability configuration. This process ensures that capability updates are both performed safely and stored permanently for future use.

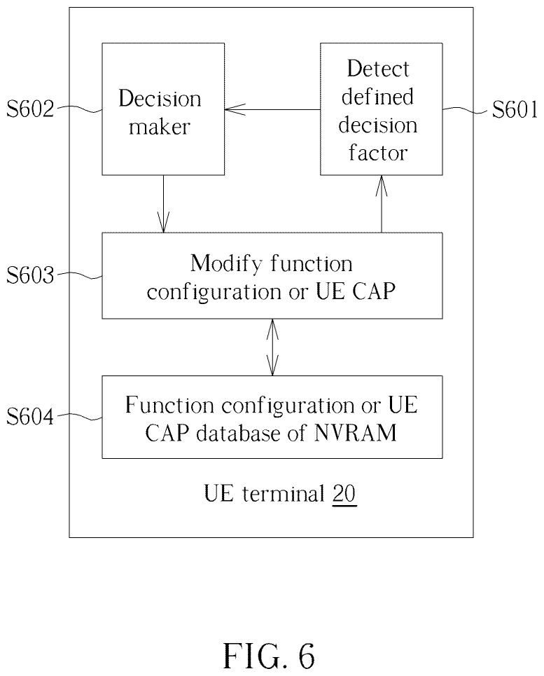

FIG. 6 is a functional block diagram illustrating the internal logic of the UE terminal 20 for implementing the dynamic capability exchange method of the UE terminal 20. In FIG. 6, a robust framework is provided for an operation based on network (NW) information, such as a Public Land Mobile Network (PLMN) identifier, and vendor information. The framework includes a software module capable of detecting a defined decision factor, with a particular focus on the composite factor of the NW information and the vendor information. After detection, the decision factor is transferred to a decision maker module, which is configured to judge an appropriate course of action, such as performing a temporary runtime change or a persistent change involving an update to the NVRAM 20c. The framework in FIG. 6 further includes another software module configured to receive the judgment from the decision maker, perform the associated capability modification, and subsequently perform the UE Capability (CAP) exchange procedure or perform an associated function based on the new configuration. Details of the internal logic of the UE terminal 20 are illustrated below. The logic can be performed by the processor 20b executing instructions stored in the NVRAM 20c. The process includes several functional steps S601 to S604, corresponding to different functional modules.

At step S601, a detection module (detect defined decision factor) detects a defined decision factor for a capability configuration update. The decision factor may include an insertion of a SIM card, an identifier of a camped network, or a combination of the camped network identifier and the network vendor information received from the network device 10.

At step S602, the detected decision factor is transferred to a decision-making module (decision maker). The decision-making module judges or determines the appropriate course of action based on the received factor. A key judgment performed by the decision maker is whether to perform a temporary runtime change only, or to perform a change that is made persistent by updating the NVRAM 20c. The processor is configured to selectively update the non-volatile memory.

At step S603, a modification module (modify function configuration or UE capability (CAP)) receives the judgment from the decision maker and executes the corresponding capability modification. The modification module involves changing the configuration of one or more capability categories of the UE terminal 20.

At step S604, the modification module interacts with a database (function configuration or UE CAP database). The interaction is bidirectional. The modification module reads the current configuration from the database to perform the update, and if the decision from step S602 was to make the change persistent, it writes the new, updated configuration back to the database. The database is stored in the NVRAM 20c. After the modification is complete, the UE terminal 20 may then perform the capability exchange procedure with the network.

It is noted that the process illustrated in FIG. 6 can be a continuous loop. After the modification is performed at step S603 and any subsequent capability exchange procedure is completed, the logic of the UE terminal 20 can return to step S601. The detection module can then continuously monitor for new or changed decision factors to enable further dynamic updates as the operational context of the UE terminal 20 changes. Steps S601 to S603 create a robust and adaptive loop.

In another embodiment, a robust framework for managing UE terminal vendor information operation is introduced. The framework includes several software capabilities that can be performed by the processor 20b of the UE terminal 20. First, the framework includes a software module capable of detecting the network (NW) vendor information. The detection of the network vendor information is based on receiving one of a plurality of message types from the network device 10. For example, the message types may include a UE capability enquiry message, a Radio Resource Control (RRC) reconfiguration message, or an RRC system information message.

Second, the framework includes a software module configured to compose the UE terminal's vendor information. The information may be based on one of, a partial combination of, or all of a combination of several components. The components include a hardware identifier of the UE terminal, associated software branch information, an associated software mass production phase, and an associated software release time or version number.

Furthermore, the framework includes a software module capable of reporting the composed UE terminal vendor information to the network device 10. The reporting capability is governed by security conditions. In a general case, the UE terminal vendor information is provided only after a secure communication channel with message ciphering has been established with the network device 10. However, an exception exists for an emergency service. If an emergency service is performed without message ciphering being configured, only a partial set of the UE terminal vendor information, for example, only the UE vendor hardware identifier is transmitted if required.

In the architecture for capability exchange between the network device 10 and the UE terminal 20, any technology modification or hardware replacement falls into the scope of the embodiment. For example, in an embodiment, the mechanism for the network device 10 to transmit its network vendor information is realized by embedding the information within a standard message, such as the UE capability enquiry message. The network vendor information may be encoded by repurposing an information element (IE) that is conventionally designated for another purpose. For example, the network vendor information can be embedded in an IE corresponding to an unused frequency band. In one implementation, an unused band identifier, such as E-UTRA band 200, is used to signal the presence of vendor information. The specific identity of the manufacturer can then be encoded in sub-parameters of that IE, such as the bandwidth class downlink and bandwidth class uplink. For instance, a specific combination of values for these sub-parameters may correspond to a first manufacturer, while another combination may correspond to a second manufacturer. Furthermore, another unused frequency band identifier, such as E-UTRA band 202, may be used in a similar manner to convey version information of the network device 10.

In another embodiment, the mechanism for the UE terminal 20 to transmit its UE terminal vendor information is realized by repurposing fields within a standard capability report message (e.g., the UE Capability Information message). The UE terminal 20 may embed its vendor information, which includes details such as a hardware identifier and software version into one or more deprecated or dummy IEs. These dummy IEs are fields that are defined in a standard but are no longer actively used for their original purpose. For example, a dummy IE such as a MAC parameter common delta dummy IE may be repurposed by the processor 20b to carry a part of the UE terminal vendor information. As a result, the UE terminal 20 can convey detailed, vendor-specific information to the network device 10 without requiring changes to the fundamental structure of existing 3GPP messages.

For the network side, the network device 10 transmits a message to the UE terminal 20. The message includes network vendor information for identifying a manufacturer of the network device 10 and requests the UE terminal 20 to report its capability information. Subsequently, the network device 10 receives capability report information from the UE terminal 20 in response to the message. The received capability report information includes a capability configuration of the UE terminal 20 and at least a portion of UE terminal vendor information. In some embodiments, the transmission of the message by the network device 10 is performed in response to receiving an update notification message from the UE terminal 20, which indicates that the capability configuration of the UE terminal 20 has changed. After receiving the update notification message, the network device 10 may first purge a previously stored capability configuration of the UE terminal 20 before transmitting the message. Furthermore, after receiving the UE terminal vendor information, the network device 10 may adjust a network configuration for the UE terminal 20 based on the received information to achieve better performance and interoperability.

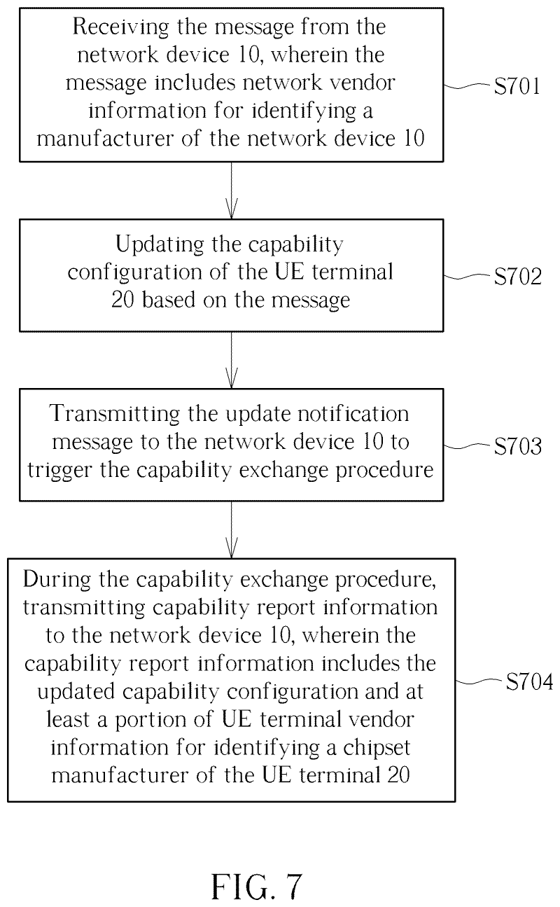

FIG. 7 is a flowchart of performing a method for performing the capability exchange with the network device 10 by the UE terminal 20. The method includes steps S701 to S704. Any technology modification or hardware replacement falls into the scope of the embodiment. Steps S701 to S704 are illustrated below.
step S701: receiving the message from the network device 10, wherein the message includes network vendor information for identifying a manufacturer of the network device 10;
step S702: updating the capability configuration of the UE terminal 20 based on the message;
step S703: transmitting the update notification message to the network device 10 to trigger the capability exchange procedure;
step S704: during the capability exchange procedure, transmitting capability report information to the network device 10, wherein the capability report information includes the updated capability configuration and at least a portion of UE terminal vendor information for identifying a chipset manufacturer of the UE terminal 20.

Details of Steps S701 to S704 are previously illustrated. Thus, they are omitted here. Embodiments of the capability exchange between the network device 10 and the UE terminal 20 provide significant advantages over conventional methods. Conventional methods rely on coarse triggers like a Public Land Mobile Network (PLMN) identifier, which cannot distinguish between different infrastructure vendors within a single operator's network, leading to sub-optimal performance. In contrast, the embodiment enables the UE terminal 20 to make decisions based on specific network vendor information, allowing for precise and adaptive capability configuration. Furthermore, a bidirectional exchange of vendor information facilitates mutual optimization between the UE terminal 20 and the network device 10, resulting in a more robust, better-performing, and reliable wireless communication environment.

In summary, the embodiments provide a method and apparatus for a dynamic and adaptive capability exchange. Unlike conventional methods that rely on coarse identifiers, the embodiments enable the UE terminal to receive and utilize specific network vendor information from the network device. Based on the granular information, the processor within the UE terminal is configured to update its capability configuration. For example, it includes judging whether an update would affect an ongoing connection to select an appropriate update procedure, selectively making the configuration changes persistent by writing to the NVRAM, and modifying specific capability categories such as Radio Frequency (RF), Radio Resource Control (RRC), or Mobility Management (MM) capabilities. Furthermore, the framework facilitates a secure, bidirectional information exchange by allowing the UE terminal to report its detailed vendor information back to the network device. As a result, the embodiments provide a robust, secure, and mutually optimized communication mechanism with enhanced performance and interoperability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing a capability exchange with a network device by a user equipment (UE) terminal, the method comprising:
receiving a message from the network device, wherein the message comprises network vendor information for identifying a manufacturer of the network device;
updating a capability configuration of the UE terminal based on the message;
transmitting an update notification message to the network device to trigger a capability exchange procedure; and
during the capability exchange procedure, transmitting capability report information to the network device, wherein the capability report information comprises the updated capability configuration and at least a portion of UE terminal vendor information for identifying a chipset manufacturer of the UE terminal.

2. The method of claim 1, wherein the message is one of a Radio Resource Control (RRC) reconfiguration message, an RRC system information message, or a UE capability enquiry message, and the update notification message is a mobility registration update message.

3. The method of claim 1, wherein the update notification message is transmitted without interrupting an ongoing connection with the network device.

4. The method of claim 1, wherein the update notification message is transmitted only after an ongoing connection with the network device is interrupted.

5. The method of claim 4, further comprising:
updating a non-volatile memory of the UE terminal with the updated capability configuration.

6. The method of claim 1, wherein updating the capability configuration is performed in response to detecting at least one decision factor, and the at least one decision factor comprises at least one of:
an insertion of a SIM card into the UE terminal;
an identifier of a camped network of the UE terminal; or
a combination of the identifier of the camped network and the network vendor information.

7. The method of claim 1, wherein updating the capability configuration comprises:
modifying at least one of a plurality of capability categories stored in a database of a non-volatile memory of the UE terminal;
wherein the plurality of capability categories comprises at least one of a radio frequency (RF) band capability, a Radio Resource Control (RRC) or Mobility Management (MM) capability, or an on/off switching state of a specific function of the UE terminal.

8. The method of claim 1, wherein the UE terminal vendor information comprises at least one of:
a hardware identifier of the UE terminal;
software branch information associated with the UE terminal;
a software mass production phase associated with the UE terminal; or
a software release time or a software version number associated with the UE terminal.

9. The method of claim 1, wherein the UE terminal vendor information is transmitted only after a secure communication channel has been established with the network device.

10. The method of claim 9, wherein for an emergency service performed without the secure communication channel being established, a partial set of the UE terminal vendor information is transmitted to the network device, and the partial set comprises a hardware identifier of the UE terminal.

11. A method for performing a capability exchange with a user equipment (UE) terminal by a network device, comprising:
transmitting a message to the UE terminal, wherein the message comprises network vendor information for identifying a manufacturer of the network device and requests the UE terminal to report its capability information; and
receiving capability report information from the UE terminal in response to the message, wherein the capability report information comprises a capability configuration of the UE terminal and at least a portion of UE terminal vendor information for identifying a chipset manufacturer of the UE terminal.

12. The method of claim 11, further comprising:
receiving an update notification message from the UE terminal;
wherein transmitting of the message is performed in response to the update notification message, and the update notification message indicates that the capability configuration of the UE terminal has changed.

13. The method of claim 12, further comprising:
purging a previously stored capability configuration of the UE terminal by the network device after receiving the update notification message.

14. The method of claim 11, wherein the network vendor information is embedded in an information element (IE) corresponding to an unused frequency band.

15. The method of claim 11, further comprising:
establishing a secure communication channel with the UE terminal before receiving the capability report information comprising the at least a portion of UE terminal vendor information.

16. The method of claim 11, further comprising:
adjusting a network configuration for the UE terminal based on the at least the portion of UE terminal vendor information received by the network device.

17. A user equipment (UE) terminal comprising:
a transceiver;
a processor coupled to the transceiver; and
a non-volatile memory coupled to the processor and configured to store data;
wherein the transceiver is configured to receive a message from a network device, the message comprises network vendor information for identifying a manufacturer of the network device, the processor updates a capability configuration of the UE terminal based on the message, the processor controls the transceiver to transmit an update notification message to the network device to trigger a capability exchange procedure, and during the capability exchange procedure, the processor controls the transceiver to transmit capability report information to the network device, the capability report information comprises the updated capability configuration and at least a portion of UE terminal vendor information for identifying a chipset manufacturer of the UE terminal.

18. The UE terminal of claim 17, wherein the processor is configured to detect at least one decision factor and updates the capability configuration based on the at least one detected decision factor, and the at least one decision factor comprises at least one of:
an insertion of a SIM card into the UE terminal;
an identifier of a camped network of the UE terminal; or
a combination of the identifier of the camped network and the network vendor information.

19. The UE terminal of claim 17, wherein the processor is configured to selectively update the non-volatile memory with the updated capability configuration to make the updated capability configuration persistent.

20. The UE terminal of claim 17, wherein the processor is further configured to modify at least one of a plurality of capability categories stored in the non-volatile memory, and the plurality of capability categories comprises at least one of:
a radio frequency (RF) band capability;
a Radio Resource Control (RRC) or Mobility Management (MM) capability; or
an on/off switching state of a specific function of the UE terminal.
